(19) United States
(12) Patent Application Publication
(10) Pub. No.: US 2025/0047471 A1
(43) Pub. Date: Feb. 6, 2025

(54) Protected Sensor Data Communication

(71) Applicant: Texas Instruments Incorporated, Dallas, TX (US)

(72) Inventors: Veeramanikandan Raju, Bangalore (KA); Anand Kumar G, Bangalore (KA)

(21) Appl. No.: 18/362,695

(22) Filed: Jul. 31, 2023

(51) Int. Cl. H04L 9/06

(52) U.S. Cl. CPC H04L 9/0662

(57) ABSTRACT

A network-communicating device with a signal input adapted to receive a sensor-derived signal; an analog-to-digital converter (ADC) having an input coupled to the signal input and an output; a data scrambling circuit having an input coupled to the output of the ADC and an output; a watermark insertion circuit having an input coupled to the output of the data scrambling circuit and an output; and a signal output coupled to the output of the watermark insertion circuit.

### CROSS-REFERENCE TO RELATED APPLICATION

Not applicable.

### BACKGROUND

The described examples relate to communication of sensor data.

In various applications, sensors are used to sense a corresponding parameter, and a value associated with the sensed parameter may be communicated by a communication device that includes, or communicates with, the sensor. In some examples, the communication device includes an analog-to-digital converter (ADC), which converts an analog output from a sensor into corresponding digital values, so that the sensor value may be periodically converted by the ADC to provide a sequence of digital values representing the sensed parameter. The communication device also may include transmitter (or transceiver) circuitry and/or functionality to communicate the ADC values to a remote location, for example wirelessly to a local or remote network. Such systems may be embodied in various forms, for example in internet of things (IoT) technology. IoT or other sensing/communication devices may be used in numerous sensing applications, for example in an industrial environment and where numerous sensors, as part of or in combination with respective communication devices, may be distributed to sense and communicate data pertaining to the environment.

Certain industries and applications for communications devices as described above are showing increased need for protecting sensed data values. For example, while personal electronics may have a lesser degree of security concern, industrial sensing may include highly private, confidential, or sensitive information. While such data has a need for restriction, it likewise may have considerable informational and/or commercial value, for example in applications involving machine learning and artificial intelligence. These values are typically realizable by communicating the data to a remote network, for example to the cloud or global Internet, from where other applications having access to the remote network can process the data. Further, the processing can result in return control to the communication devices that sense such data, or to other considerations relating to the industrial environment where the sensor(s) are located. In all events, there is a tradeoff between communicating such data and preventing it from being accessed in an unauthorized manner.

Examples are provided in this document that may improve on various of the above considerations as well as other concepts, as further detailed below.

### SUMMARY

In one example, there is a network-communicating device, comprising a signal input adapted to receive a sensor-derived signal; an analog-to-digital converter (ADC) having an input coupled to the signal input and an output; a data scrambling circuit having an input coupled to the output of the ADC and an output; a watermark insertion circuit having an input coupled to the output of the data scrambling circuit and an output; and a signal output coupled to the output of the watermark insertion circuit.

Other aspects are also disclosed and claimed.

### BRIEF DESCRIPTION OF THE DRAWINGS

FIG. 1 is an electrical block diagram of a communications device 100.

FIG. 2 is an electrical diagram of a communication device 200, as an example implementation for the FIG. 1 communications device 100.

FIG. 3 is a partial diagram of the FIG. 2 scrambler configurator circuit 202.

FIG. 4 is a partial diagram of the FIG. 2 watermark insertion engine circuit 122 and the insertion of watermark information in the data stream.

FIG. 5 is an electrical diagram of another example implementation 500 for the FIG. 1 communications device 100.

FIG. 6 illustrates a sequence of 16 bits B1 through B16, forming a single digital data block DBx, as output from the FIG. 1 ADC 118 and provided to the scrambler circuit 120.

FIG. 7 is an electrical diagram of another example implementation 700 for the FIG. 1 communications device 100.

FIG. 8 illustrates a sequence of N data blocks, DB1 through DBN, with selective scrambling applied to selected ones of the data blocks.

### DETAILED DESCRIPTION

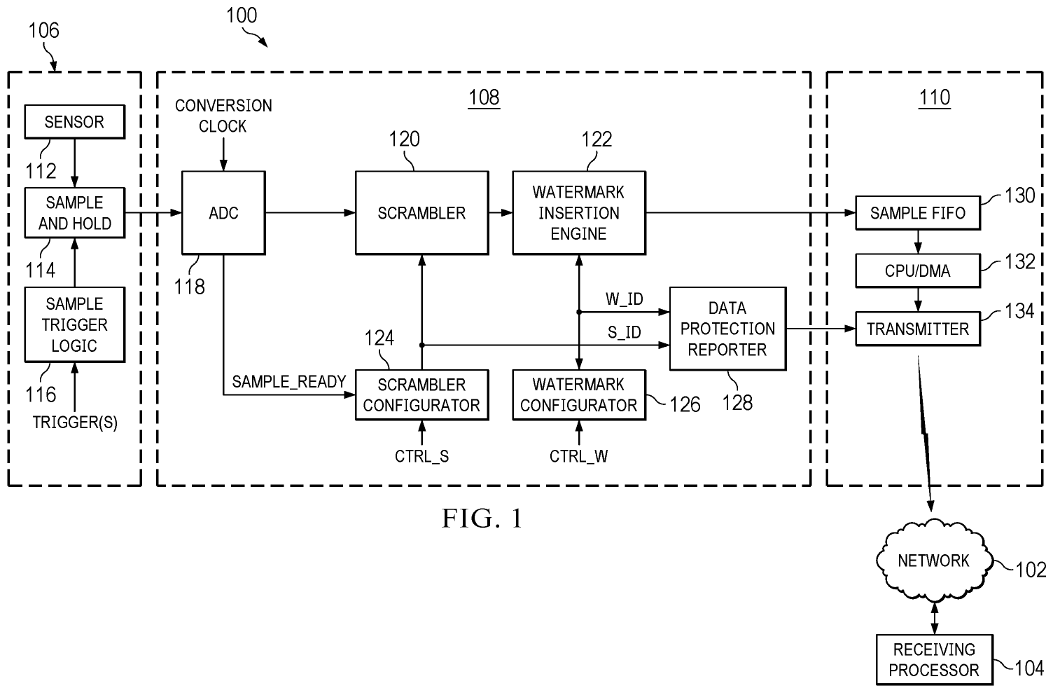

FIG. 1 is an electrical block diagram of a communications device 100. The communications device 100 may be implemented as part of various device applications, for example with particular advantages in commercial or industrial applications, in which sensor devices are prolific and there is a heightened sensitivity toward protecting data when it is communicated remotely. The communications device 100 may be powered by a battery or a continuous or switched (e.g., line) power source. The communications device 100 is a network-communicating device and, as such, communicates with a network 102. A receiving processor 104 is also coupled to the network 102, so that the receiving processor 104 may receive and process information from the communications device 100, via the network 102. Bidirectionally, the receiving processor 104 also may communicate back to the communications device 100, via the network 102.

The communications device 100 includes one or more circuits, which may be separable or provided as one more integrated circuits (ICs). The IC(s) will be described as, and for purposes of introduction are divided into, three circuit domains: (i) a data sensing domain 106; (ii) a digital data production domain 108; and (iii) a data transmission domain 110. The various blocks in the three circuit domains can be implemented with circuitry having separable or overlapping boundaries, and may be implemented in part by sequential/processing/executing circuitry, such as logic circuitry, a controller, a processor, and the like. Such circuitry also may include, or have access to, programming code accessible from a readable memory store, where access and execution of such programming code can implement some of the functionality described in this document. The data sensing domain 106 has an output connected to an input of the digital data production domain 108. The digital data production domain 108 has an output connected to an input of the data transmission domain 110. Generally, the data sensing domain 106 senses data, for example applicable to functionality of the communications device 100. The data sensing domain 106 outputs the sensed data to the digital data production domain 108. The digital data production domain 108 converts the sensed data to digital values that are each communicated as a data block, and it also performs additional data protection, for example by scrambling data within a data block (which may be selective to some blocks or apply to all blocks) and by inserting a watermark(s) into selected locations along a stream of the data blocks. The digital data production domain 108 also optionally reports data protection information regarding the scrambling or the watermark, to the data transmission domain 110. The data transmission domain 110 wirelessly transmits the scrambled and watermarked data, and optionally the data protection information, to the network 102, so long as the network 102 is within range of the communications device 100. Thereafter, the protected data may be processed by the receiving processor 104, by accessing it from the network 102.

The data sensing domain 106 includes a sensor 112, a sample and hold circuit 114, and a sample trigger logic circuit 116. An output of the sensor 112 is connected to a data input of the sample and hold circuit 114. An output of the sample trigger logic circuit 116 is connected to an enable input of the sample and hold circuit 114. A trigger signal, or signals, is provided to an input of the sample trigger logic circuit 116. The sensor 112 includes circuitry for sensing one or more attributes, for example with the attribute being present and proximate or within the configuration that includes the communications device 100. Examples of such an attribute may include pressure, acoustics, temperature, or others. The sensor 112 also produces an analog signal, corresponding to or representing the sensed attribute. The analog signal is provided to the sample and hold circuit 114 input, which when instructed by the sample trigger logic circuit 116, samples the analog signal from the sensor 112 and holds it at a near constant voltage (and/or current) during an analog-to-digital conversion. Specifically, one or more trigger signals may be provided by either software, or hardware, or both. In response to assertion of one or more of these trigger signals, the sample trigger logic circuit 116 outputs an enabling signal to the sample and hold circuit 114 enable input, and the sample and hold circuit 114 responds by sampling the analog signal from the sensor 112 and holding that value (e.g., voltage) for a predetermined duration. Accordingly, if the analog output from the sensor 112 changes during the predetermined period, the output of the sample and hold circuit 114 remains unchanged.

The digital data production domain 108 includes a data path with an ADC 118, a scrambler circuit 120, and a watermark insertion engine circuit 122. An input of the ADC 118 is connected to receive a sensor-derived (e.g., sampled) signal, here from an output of the data sensing domain 106. The ADC 118 is operated (cycled) by a conversion clock signal. A data output of the ADC 118 is connected to an input of the scrambler circuit 120. A data output of the scrambler circuit 120 is connected to an input of the watermark insertion engine circuit 122. The output of the watermark insertion engine circuit 122 provides the output of the digital data production domain 108.

The digital data production domain 108 also includes various control circuitry. A scrambler configurator circuit 124 has an output coupled to a control input of the scrambler circuit 120. A watermark configurator circuit 126 is bidirectionally coupled to a control port of the watermark insertion engine circuit 122. The various control circuitry is appropriately synchronized for controlling circuitry within the digital data production domain 108. For example, a SAMPLE_READY output may be connected from the ADC 118 to an enable input of the scrambler configurator circuit 124, so as to facilitate proper timing of the scrambler configurator circuit 124, and the scrambler circuit 120, as the ADC 118 provides each digital value output. As also detailed below, the scrambler configurator circuit 124 receives a control signal input CTRL_S, and the watermark configurator circuit 126 receives a control signal input CTRL_W, with each control signal for providing a respective control, which in some instances may be user-configurable, so as to configure and/or select among alternative manners of scrambling data and inserting a watermark into the data stream that includes the sensed data values from the ADC 118. Additionally, each of the scrambler configurator circuit 124 and the watermark configurator circuit 126 may include sufficient circuitry to implement the user selection, for example as a programmable control register, selection table, or the like. Lastly, the digital data production domain 108 includes a data protection reporter circuit 128. A first input of the data protection reporter circuit 128 is coupled to receive scramble identification information, S_ID, from the scrambler configurator circuit 124, and a second input of the data protection reporter circuit 128 is coupled to receive watermark identification information, W_ID, from the watermark configurator circuit 126. An output of the of the data protection reporter circuit 128 is connected to the data transmission domain 110.

The general operation of the digital data production domain 108 is now described, with additional details provided later in connection with various alternative implementation examples. The ADC 118 samples analog signals from the data sensing domain 106, as synchronized and at a frequency set by the conversion clock, and in response, outputs a corresponding digital data block of N bits (e.g., N=16) that is proportional to the voltage at the input of the ADC 118. The N-bit data block continues along the data path, from the ADC 118 to the scrambler circuit 120, where the data block may be scrambled, under control of the scrambler configurator circuit 124. Thereafter, the data block, potentially scrambled, is output from the scrambler circuit 120 to the watermark insertion engine circuit 122. The watermark insertion engine circuit 122 is operable to insert a watermark, or in some examples one of various different types of watermarks, into the data stream that includes the data blocks received from the scrambler circuit 120. Further, options associated with the watermark insertion engine circuit 122 are provided under control of the watermark configurator circuit 126.

Additional operation of the scrambler circuit 120 is now described. Each time a digital sample value is ready from the ADC 118, the ADC 118 asserts SAMPLE_READY as coupled to the scrambler configurator circuit 124. The scrambler configurator circuit 124 then controls the scrambler circuit 120 to apply a scrambling technique, when desired. As further detailed below, in one example, scrambling is applied to each M-bit data block, and in a different example, scrambling may be selectively applied, that is, only to some M-bit data blocks, for example depending on the value represented by the data block. Accordingly, when scrambling is desired, the scrambler configurator circuit 124 outputs appropriate control to indicate a data block is to be scrambled, and also the manner of scrambling, with examples provided below. Conversely, when scrambling is not enabled, the scrambler circuit 120 may be inhibited from sampling a data block(s), for example to save power. Additionally, in some examples, when data is scrambled, the scrambler configurator circuit 124 provides identifying information, for example as mapping, table, flag(s), or other indication of which data units from the ADC 118 are scrambled and how the scrambling is applied, with that information represented in FIG. 1 as the S_ID. The S_ID signal is provided to the data protection reporter circuit 128, which is coupled to provide this information, at an appropriate time and in an appropriate form, to the transmit domain 110, so the S_ID also may be communicated to the network 102 and the receiving processor 104. When the receiving processor 104 receives the S_ID, it is thereby notified of which data it receives from the communications device 100 is scrambled and how the scrambling is applied, and in response the receiving processor 104 may then appropriately descramble only those scrambled data blocks, while processing the remaining blocks received from the communications device 100 as unscrambled data.

Additional operation of the watermark engine circuit 122 is now described. Each time the watermark insertion engine circuit 122 receives a data block from the scrambler circuit 120, the watermark configurator circuit 126 is informed of the data block receipt event (e.g., via the bidirectional coupling between the two circuits). In response, the watermark configurator circuit 126 controls the watermark insertion engine circuit 122 to insert watermark information, which may be one or more bits, inserted at various locations between certain ones of the received data blocks. The insertion location from the watermark configurator circuit 126 may be user-configurable, for example via CTRL_W. Additionally in some examples, the watermark configurator circuit 126 provides identifying information, for example as mapping, table, flag(s), or other indication of the positioning of the watermark information among the data blocks received by the watermark insertion engine circuit 122 from the scrambler circuit 120, with that information represented in FIG. 1 as the W_ID. The W_ID signal is provided to the data protection reporter circuit 128, which recall is coupled to provide this information to the transmit domain 110, so the W_ID also may be communicated to the network 102 and the receiving processor 104. When the receiving processor 104 receives the W_ID, it is thereby notified of watermark information location among the data it receives from the communications device 100, and in response the receiving processor 104 may then appropriately determine if the watermark information corresponds to an expectation, for example if that information matches an intended watermark of the recipient associated with the receiving processor 104.

The data transmission domain 110 includes a sample first in first out (FIFO) circuit 130, a central processing unit (CPU)/direct memory access (DMA) circuit 132, and a transmitter 134. An input of the sample FIFO circuit 130 is connected to an output of the watermark insertion engine circuit 122. An output of the sample FIFO 130 is connected to an input of the CPU/DMA circuit 132. An output of the CPU/DMA circuit 132 is connected to an input of the transmitter 134. The output of the transmitter 134 is intended to indicate wireless transmission of data, for example to an appropriate radio frequency/antenna or other applicable interface for wireless communications.

The operation of the data transmission domain 110 is now described. As digital data blocks, either scrambled or unscrambled and with interspersed watermarking, are output by the watermark insertion engine circuit 122, those samples and watermark information are stored into the sample FIFO 130. The CPU/DMA circuit 132 represents one or more alternatives for retrieving data from a memory store, which in this case is the sample FIFO 130, and forwarding the retrieved data for transmission. In the illustrated example, the retrieved and forwarded data is provided to the transmitter 134, which transmits such data wirelessly to the network 102. Accordingly, the transmitter 134 provides a data gateway to the network 102, within range of the transmitter, for example using a WiFi-implemented or other wireless protocol. Once the data reaches the network 102, it may be processed by an appropriate device(s) having access, either directly or through other intermediate paths or nodes, to that network 102, so as to include the receiving processor 104.

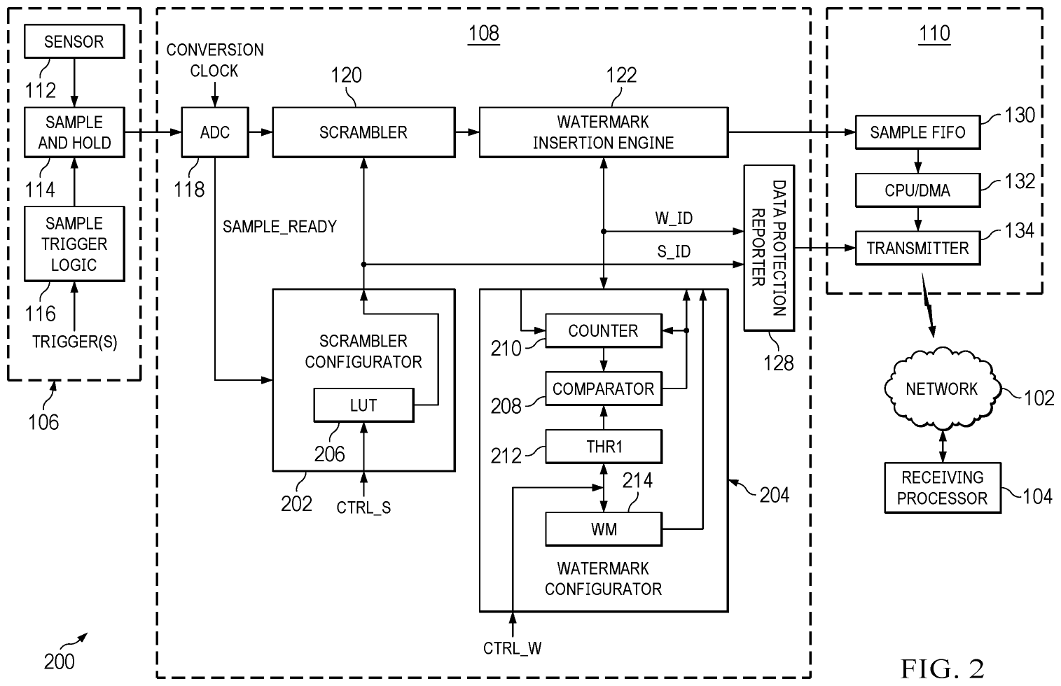

FIG. 2 is an electrical diagram of a communication device 200, as an example implementation for the FIG. 1 communications device 100. In FIG. 2 and later drawings, common reference numbers are used with FIG. 1 to illustrate the same, or comparable, circuit blocks. Accordingly, the following discussion focuses primarily where certain blocks are modified or explained with respect to particular implementation details.

In FIG. 2, in the digital data production domain 108, a scrambler configurator circuit 202 and a watermark configurator circuit 204 are shown in place of the respective FIG. 1 scrambler configurator circuit 124 and watermark configurator circuit 126. The scrambler configurator circuit 202 includes a lookup table (LUT) 206, which optionally may be user configurable by CTRL_S. An output of the LUT 206 is connected to the scrambler circuit 120. The watermark configurator circuit 204 includes a comparator 208, a counter 210, a threshold storage circuit 212 for storing a threshold THR1, and a watermark storage circuit 214 for storing a watermark WM. Each of the THR1 (as stored in the threshold storage circuit 212) and the WM (as stored in the watermark storage circuit 214) may be internally provided, or alternatively it may be user-configurable, for example via CTRL_W. The THR1 is connected to a first input of the comparator 208. An output of the counter 210 is connected to a second input of the comparator 208. The output of the comparator 208 is connected to an enable (or trigger) input of the watermark insertion engine circuit 122, and also to a clear input of the counter 210. An input of the counter 210 is connected to the watermark insertion engine circuit 122, for purposes of incrementing a count in the counter 210. As detailed below, the counter 210 counts a number of data blocks received by the watermark insertion engine circuit 122, and the watermark configurator circuit 204 may control the watermark insertion engine circuit 122 to selectively insert the watermark information each time the count reaches the THR1.

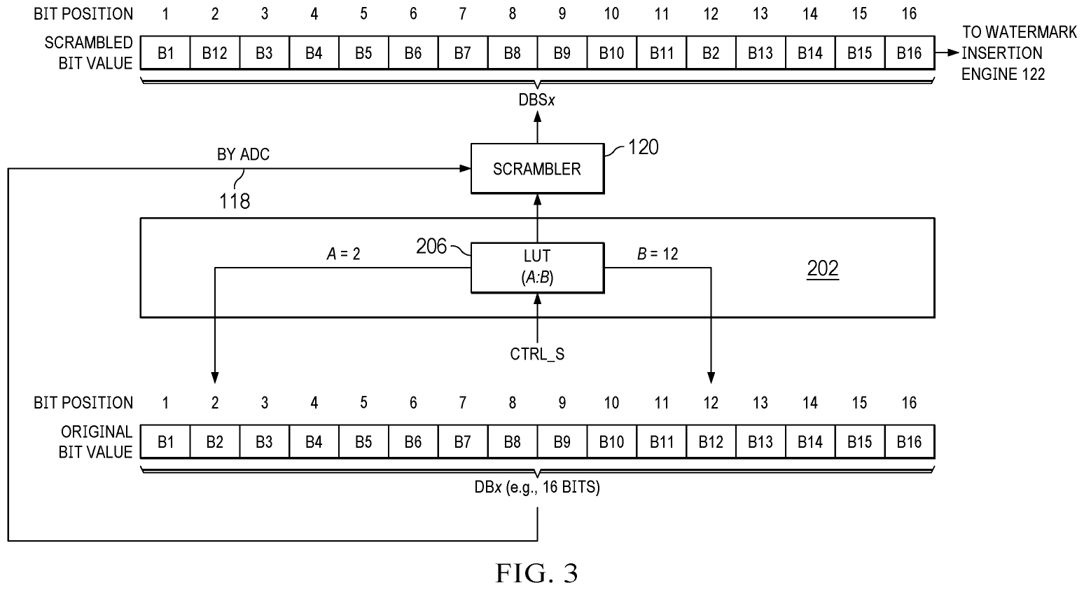

FIG. 3 is a partial diagram of the FIG. 2 scrambler configurator circuit 202, in combination with example data values, to illustrate the scrambler configurator circuit 202 operation. Along the bottom horizon of FIG. 3, a single digital data block DBx is shown, as output from the FIG. 1 ADC 118 and provided to the scrambler circuit 120. In the illustrated example, DBx has 16 bits, each shown with an indicator of Bz, where the reference z indicates for a bit its respective illustrated bit position. For example, bit B1 is at bit position 1, bit B2 is at bit position B2, and so forth up to bit B16 at bit position 16. FIG. 3 further illustrates diagrammatically that the LUT 206 stores a data swapping coordinate pair, shown as (A:B). The values of A and B are stored in the LUT 206 and output to the scrambler circuit 120, so as to control/indicate data at respective bit positions that are to be swapped by the scrambler circuit 120. In the illustrated example, the LUT 206 stores A=2 and B=12, and couples that as control to the scrambler circuit 120. In response, the scrambler circuit 120 swaps the bit B2 at the LUT-indicated bit position A=2 with the bit B12 at the LUT-indicated bit position B=12. As a result, the upper horizon of FIG. 3 illustrates a data block DBS.x, which results from the scrambler circuit 120 under control of the LUT-indicated swap. Accordingly, in the illustrated example and with (A:B)=(2,12), then in DBSx, the bit B12 appears at the bit position B2, and the bit B2 appears at the bit position B12, with all other bits in DBS.x matching the same values and positions as in the original bit values of DBx. Note that A and B may be provided by CTRL_S, for example, or alternatively from some other source (e.g., preprogrammed, periodically internally generated, and so forth). Lastly, FIG. 3 illustrates, consistent with earlier Figures, that that scrambled data block DBSx is output to the watermark insertion engine circuit 122.

The illustration and discussion of FIG. 3 are by way of example. In other examples, other swapping may be implemented. For example, for an N>2 bit data block, more than two bits may be swapped. As another example, the manner of swapping more than two bits may be according to various methods or patterns. For example, circular rotation of swapped bits may be implemented, for instance moving each designated swap bit to the next highest (or lowest) significant bit position, and rotating around the data block so that any bit moved beyond the highest (or lowest) significant bit position circles around to the least (or most) significant bit position indicated for a swap. In such a scenario, assume in FIG. 3 that the LUT-indicated bit positions include three designations, A=2, B=12, and C=15, and with a bit swapping rotationally to the next most significant bit position. In this case, the data value at position A=2 is moved to the B=12 position, the data value at position B=12 is moved to the C=15 position, and the data value at the position of C=15 is moved to the A=2 position. In yet another alternative, multiples of bit pairs can be swapped. For example in such a scenario, assume in FIG. 3 that the LUT-indicated bit positions include four designations, A=2, B=12, and C=15, and D=16. These four indications may be separated into pairings, for instance a first pair of {A:B} to indicate those two positions are bit swapped (the data value at position A=2 is swapped with the data value at the B=12 position), and with a second pair of {C:D} to indicate those two positions are likewise bit swapped (the data value at position C=15 is swapped with the data value at the D=16 position). In another alternative, the preceding alternatives also may be combined, such as a first pair (or other multiple of bits) of bit positions both swapping into a paired indication of more (or less) significant bit positions.

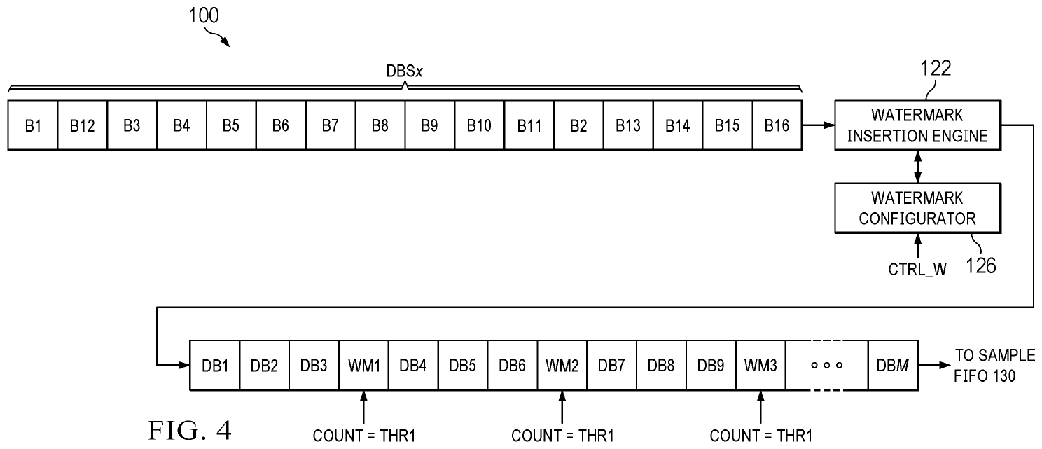

FIG. 4 is a partial diagram of the FIG. 2 watermark insertion engine circuit 122, in combination with example data values, to illustrate the watermark insertion engine circuit 122 operation. Along the top horizon of FIG. 4, a single scrambled (or potentially scrambled) data block DBSx is shown, as output from the FIG. 1 scrambler circuit 120 and provided to the watermark insertion engine circuit 122. In the illustrated example, DBSx is one data block that will be followed by an integer number M of data blocks, where FIG. 4 illustrates a sequence of such blocks DB1, DB2, . . . , DBM. In the FIG. 4 example, the watermark configurator circuit 126 includes the FIG. 3 aspects, although they are not repeated in detail, and THR1=4. Accordingly, the counter 210 is reset or initialized to a first value, for example zero, and it advances (e.g., increments) for each data block DBSx received by the watermark insertion engine circuit 122. Additionally, THR1 is set in any of the above-described manners, where in the illustrated example THR1=3. The counter thereby increments to three, for each of the first received set of three data blocks (DB1, DB2, DB3), at which point COUNT=THR1. The comparator 208 detects the match of COUNT and THR1, and signals or asserts a representative match (or other appropriate) signal to the watermark insertion engine circuit 122. In response, the watermark insertion engine circuit 122 inserts watermark information WM1 into the data sequence after the most recently received data block DB3. The asserted signal from the comparator 208 also resets the counter 210. Thereafter, the above sequence repeats until the next occurrence of the satisfied condition of COUNT=THR1, which happens in the illustrated sequence after the next three data blocks (DB4, DB5, DB6) are received, at which point again the comparator 208 asserts its output, and in response the watermark insertion engine circuit 122 inserts watermark information WM2 into the data sequence and the counter 210 is again reset. This process may continue indefinitely, or until control is otherwise changed.

The watermarking information inserted by the watermark insertion engine 122 may take various forms, in different examples. In one example, the watermark is a same number of N bits as in each data block, where in the earlier example N=16. In another example, the watermark is less than N bits, and in a particular example may be a single bit (of either a value of 0 or 1), sometimes referred in other contexts as a padding bit, between sets of blocks, with each set having THR1 blocks. Any one or more of the value, selection, and potential choice among multiple choices, may be user configurable and indicated through CTRL_W. Accordingly, the communications device 100 may be provided to a user, and the user may adapt its own watermark into use of the communications device 100. Similarly, to the extent the user also has control over operation of the receiving processor 104, the user can detect an incoming signal stream of data blocks and determine if the inserted watermark in that stream corresponds to the expectation of the user, so as to identify whether the data is that of, or intended for, that user.

Given the example of FIGS. 3 and 4, the communications device 100 data sensing domain 106 may sense (e.g., using the sensor 112) an attribute and provide a corresponding analog signal, for each of a series of sampled signals. The digital data production domain 108 may convert each analog signal sample value to a corresponding digital value data block (e.g., using the ADC 118), while scrambling selected bits in those sample data blocks (e.g., every fourth sample) and interspersing watermark information between sets of those data blocks. The data transmission domain 110 transmits a stream of scrambled data blocks, and with a watermark interspersed among data blocks, to the network 102 and thereby making them available for processing (e.g., by the receiving processor 104). The data transmission domain 110 also may transmit data protection information from the data protection reporter circuit 128, representative of one or both of scrambling and watermarking associated with the data from the ADC 118. Further, such data protection information may then be used by the receiving processor 104 to accurately unscramble the data and/or to detect and/or verify the watermark. For example, with respect to data scrambling, the LUT pairing (A:B) can be provided as part of the S_ID, and the THR1 of the threshold storage circuit 212 can be provided as part of the W_ID, with both communicated by the data transmission domain 110 to the receiving processor 104. The receiving processor 104 can then unscramble each data block DBx, by again swapping the (A:B) pair, and it may likewise detect and or verify the watermark by reference to every set of data occurring immediately after the number THR1 of data blocks DB.x.

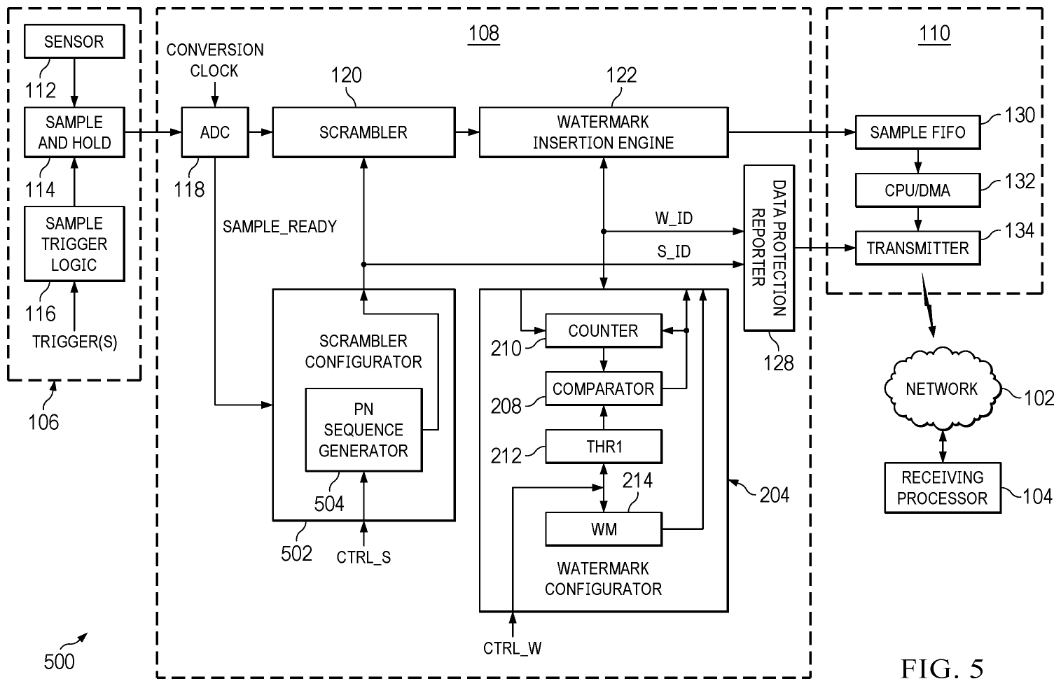

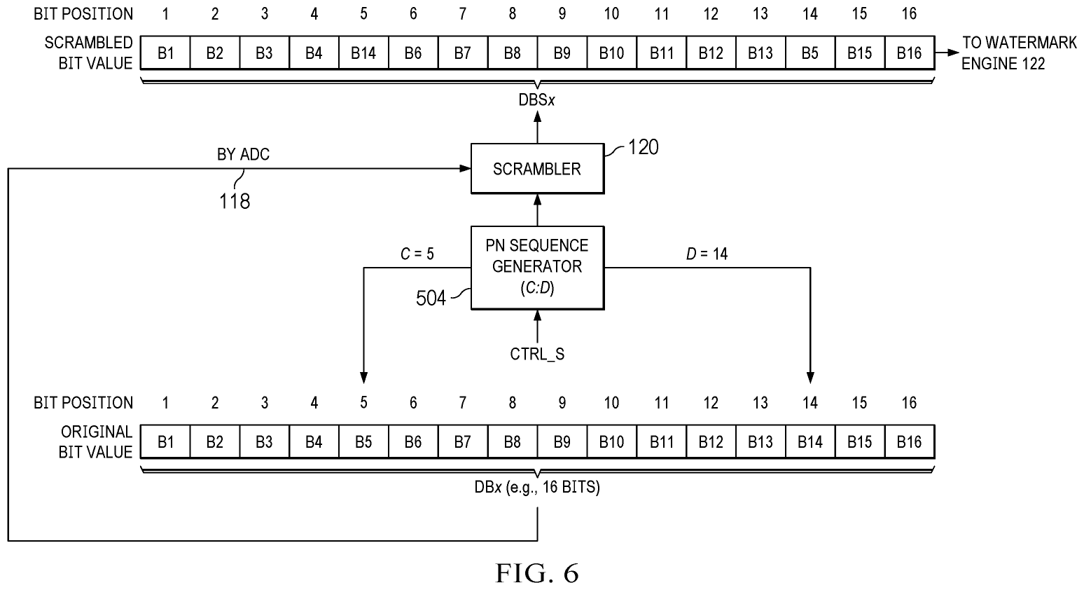

FIG. 5 is an electrical diagram of another example implementation communication device 500 for the FIG. 1 communications device 100. In FIG. 5, the scrambler configurator circuit 124 of the communications device 100 is shown as a scrambler configurator circuit 502, which includes a pseudorandom (PN) sequence generator 504. Accordingly, in one example the user-configurable CTRL_S signal can provide a random (including PN) sequence, or in an alternative example the CTRL_S signal can enable (or disable) the PN sequence generator 504. The cost of the PN sequence generator 504 depends on the degree and quality of the scrambling that needs to be achieved in the given application. The PN sequence can be seeded using different methods, for example by selecting from among a set of orthogonal codes, stored in the PN sequence generator 504, for example in an LUT. For example, one method may address such an LUT in a predictable and static manner to choose the seed from among the different values stored in that LUT. As another example, a PN may be used to choose an address in that LUT, thereby randomly accessing the seed from the LUT. In either event, the seed is then used to generate the remaining PN sequence. An example is shown in FIG. 6.

FIG. 6 illustrates a sequence of 16 bits B1 through B16, forming a single digital data block DBx, as output from the FIG. 1 ADC 118 and provided to the scrambler circuit 120. FIG. 6 further illustrates that the PN sequence generator 504 generates a data swapping coordinate pair, shown as (C:D). The values of C and D are generated in a random or pseudorandom fashion, and are appropriately provided or modified to identify (or otherwise address) two of the total N bits in DBx. In the illustrated example, the generated PNs are such that the generator 504 provides C=5 and D=14, which are coupled to the scrambler circuit 120. In response, the scrambler circuit 120 swaps the bit B5 at the bit position C=5 with the bit B14 at the bit position D=14. As a result, the upper horizon of FIG. 6 illustrates a data block DBSx, which results from the scrambler circuit 120 under control of the PN sequence generator circuit 504 indicated swap. Accordingly, in the illustrated example and with (C:D)=(5,14), then in DBSx, the bit B14 appears at the bit position B5, and the bit B5 appears at the bit position B14, with all other bits in DBSx matching the same values and positions as in the original bit values of DBx. The above description, and FIG. 6, illustrates only an instance of two PN-identified bits being swapped, but like FIG. 3, the PN-identification may be used to first identify multiple bits, with the swapping achieved in some other manner, such as by rotation, by pairings, or otherwise.

Also in connection with FIGS. 5 and 6, the S_ID provides an indication to the data protection reporter circuit 128 of the random or pseudorandom bit swapping within a data block DBx, for example providing (C:D) or an appropriate seed that can be used by the receiving processor 104 to comparably generate (C:D), so that the receiving processor 104 can unscramble each data block. For example, the generation key used to create the PN at the communications device 100 can be provided and securely reported to the receiving processor 104, by and through the data protection reporter circuit 128 and the data transmission domain 110. Different reporting examples may include at least one of two examples to securely provide this generation key. First, the key may be statically embedded for query in a given register, where the register is protected for authorized access only based on a software authentication mechanism. For example to protect the register, an application program interface (API) can be developed to provide the register value with key information, where the API also can be further protected by requiring authenticated by external means. Second, the generation key can be dynamically exchanged through a Public/Private Key challenge.

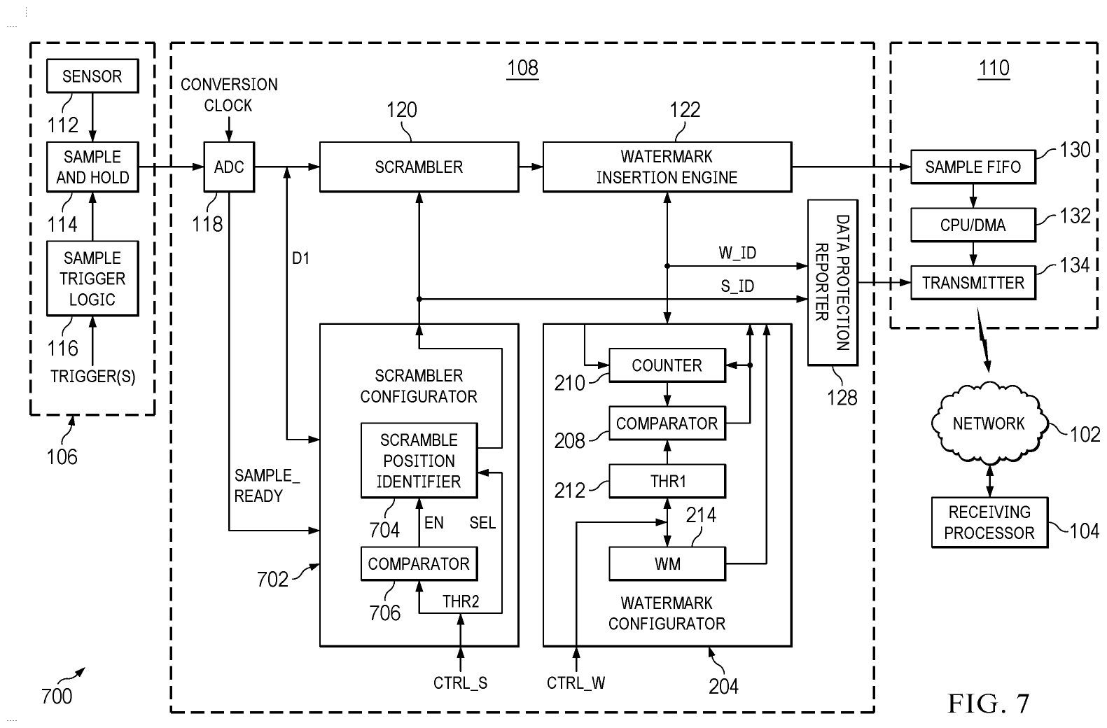

FIG. 7 is an electrical diagram of another example implementation communication device 700 for the FIG. 1 communications device 100. In FIG. 7, the scrambler configurator circuit 124 of the communications device 100 is shown as a scrambler configurator circuit 702, which includes a scramble position identifier circuit 704 and a comparator 706. The scramble position identifier circuit 704 has an output coupled to the scrambler circuit 120, to indicate at indicate at least two bit positions to the scramble circuit 120, where those bit positions are swapped as described above. The scramble position identifier circuit 704 also has an enable input (shown as EN) coupled to an enable output of the comparator 706 and a select input (shown as SEL) to control selection among alternative manners of scrambling data, for example as described earlier to indicate bit swapping positions. The comparator 706 has a first data input connected to receive the data value output from the ADC 118 (shown as D1), and a second data input connected to receive a threshold value (shown as THR2), which may be provided as part of the user control signal CTRL_S.

The operation of the scrambler configurator circuit 702 causes the scrambler circuit 120 to scramble only selective ones of the data blocks output from the ADC 118, with the selectivity based on a comparison by the comparator 706 of D1 to THR2. Specifically, the comparator 706 compares D1 and THR2, and asserts or de-asserts EN, to the scramble position identifier circuit 704, based on the comparison result. An example of the user providing USER_CONFIG=THR2, and the responsive operation, is shown below.

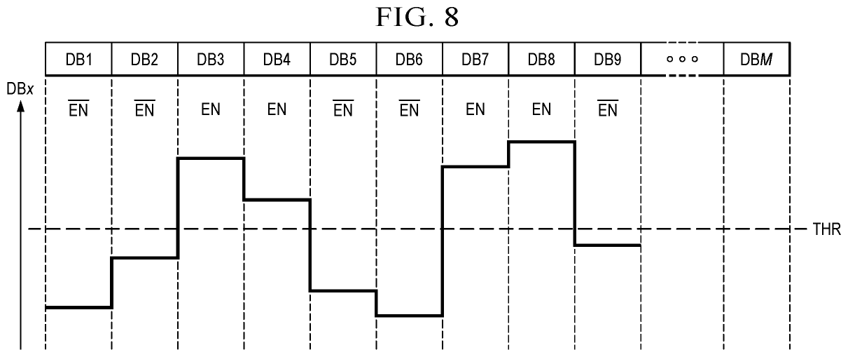

FIG. 8 illustrates a sequence of M data blocks, DB1 through DBM, in a same manner introduced above in FIG. 4, although FIG. 8 illustrates selective scrambling apart from watermark insertion. FIG. 8 also illustrates an example, in a horizontal row below the data blocks, of an enable sequence depicting the logical values of the FIG. 7 EN signal as intended to correspond, or direct, whether scrambling is applied to each respective data block DB.x. Beneath the row of EN signals, FIG. 8 illustrates the magnitude of each data block value DBx from the ADC 118. Lastly, FIG. 8 illustrates an example value for CTLR_S=THR2. In the illustrated example, some values of DBx are below THR2 (i.e., values, DB1, DB2, DB5, DB6, and DB9), and some values of DBx are above the THR2 (i.e., values DB3, DB4, DB7, and DB8). Further, the EN signal is asserted when the DB.x values is above THR2, and the EN signal is de-asserted (EN) when the DBx value is below THR2. Returning to FIG. 7, and in combination with the EN sequence of FIG. 8, note the comparator 706 will de-assert EN for the first two data block values output by the ADC 118. Accordingly, the de-asserted EN disables the scramble position identifier circuit 704, so that data values output by the ADC 118 pass through the scrambler circuit 120 without being scrambled (e.g., switching circuitry may be included in the data path so as to bypass or other inhibit scrambling from occurring). As a result, the first two data block values output by the ADC 118 are not scrambled, and pass to the watermark insertion engine circuit 122. However, for the third and fourth data block value output by the ADC 118, the comparator 706 asserts the EN signal. In response to the asserted EN signal, the scramble position identifier circuit 704 applies the scrambling method indicated to it by the SEL signal, to the third and fourth data block value output from the ADC 118, and those scrambled data block values pass to the watermark insertion engine circuit 122. The same operation continues for the remaining data values, with DB5, DB6, and DB9 remaining unscrambled by the digital data production domain 108 and passing to the data transmission domain 110, and with values DB7 and DB8 being scrambled by the digital data production domain 108 and passing to the data transmission domain 110.

Also in connection with the communications device 100, the S_ID provides an indication to the data protection reporter circuit 128 of each data value that is scrambled. In the example of FIG. 8, therefore, the S_ID identifies values DB3, DB4, DB7, and DB8 as scrambled. This information may be encoded and then reported by the data protection reporter circuit 128 to the data transmission domain 110 in various manners. In one example, the S_ID can be a fixed number of bits that map correspondingly to a like number of data values, and with complementary values either set (e.g., logical one) or cleared (e.g., logical zero) to indicate whether a corresponding data value is scrambled. For example in FIG. 8, the S_ID could be an 8-bit value, for example encoded in a circular buffer, corresponding to data values DB1 through DB8, and for the example shown, then S_ID=00110011. The S_ID also may provide additional information pertinent to the scrambling—for example, with the various alternative scrambling methods described above (e.g., a pair swap; a multiple-bit rotation; a multiple pairing swap), the S_ID may include an indication of the scrambling method. The data protection reporter circuit 128 provides the S_ID information to the data transmission domain 110, so that it may be communicated to the receiving processor 104. Note that additional security may be imposed on this information, for example communicating it along a secure channel, or with its own encryption (e.g., asymmetric key). As an alternative, note that the S_ID may be included as part of the data values, for instance by including an additional bit stamp for each data value, and with the additional bit serving as a flag for the corresponding data value, again in one state indicating the data value is scrambled, or in an another (e.g., complementary) state indicating the data value is unscrambled. Different tradeoffs may exist in the above approaches, with the secure channel increasing communication complexity, and the bit stamping including storage requirements in the data transmission domain 110.

Given the preceding, the selective bit scrambling can be achieved by the communications device 100 based on the value of each digital sample as compared to a threshold. Further, the threshold can remain the same, or can be altered, for example by user input. As one example, the threshold might be set based on anticipated patterns in the data. For example, the communications device 700, or its sensor 112, may be for sensing data that, during some low-interest periods, are expected to be low and of little consequence to the environment being sensed. In such an instance, THR2 may be set above the anticipated value(s) during the low-interest periods, so that all data during that period is unscrambled, and while therefore more susceptible to access, also of lesser concern due to being from a low-interest time frame. Conversely, during periods of interest where data is expected to exceed THR2, that data will be scrambled and therefore less vulnerable to attack. As another example, the threshold can vary, based on changes in data, for instance adjusting the threshold based on a moving average of data over a period. In all events, selective scrambling provides some protection against nefarious data attacks or access, but avoids the need for additional resources that would be required for full data stream scrambling. For instance, selective scrambling can reduce storage (e.g., memory), power consumption (e.g., battery), device size, complexity, and processing capability.

From the above, described examples provide a network-communicating device that can sample signals, selectively scramble certain of those signals, insert watermarking in to the sample stream, and transmit the sampled/watermarked signals to a network and/or processing device. Selectivity can be user controlled, whereby a user can select among types of scrambling, selectivity of scrambling, and type of watermarking. These alternatives may provide any one or more of various advantages. For example, the device may reduce or avoid attacks on ADC data sensing and thereby permit securing sensing capabilities. Selective scrambling may free up resources that otherwise would be used if all data samples are scrambled. Power and complexity may be reduced both on the transmitting and receiving sides of the sample process, in instances where not all samples are scrambled. Still further, digital watermarking is heretofore unknown in connection with ADC data and provides a manner at the hardware source end (e.g., communications device 100) that is free from hackers or other data attacks. Further, depending on the type and strength of the circuit and method that scrambles the data, the number of unique combinations of scrambling can be increased to extend it to multiple end user protections, with a counter-consideration or balance being potential costs if multiple different approaches are implemented into a same IC from which the combinations are selectable. Still further, one or more of the examples may be particularly beneficial in certain applications, for example in industrial environments. As a final example, with the additional data protection, users may more freely entrust limited access or use of their data, including on a large scale, for the vastly proliferating applications in machine learning/artificial intelligence, where such data is extremely useful and increasingly valuable/lucrative. As a result, the data from different users can coexist in such applications while still providing customers some sense of protection of the respective data of each. Other benefits include variations and modifications to the structure, where certain examples have been provided. Accordingly, additional modifications are possible in the described embodiments, and other examples are possible, within the scope of the following claims.

What is claimed is:

1. A network-communicating device, comprising:
a signal input adapted to receive a sensor-derived signal;
an analog-to-digital converter (ADC) having an input coupled to the signal input and an output;
a data scrambling circuit having an input coupled to the output of the ADC and an output;
a watermark insertion circuit having an input coupled to the output of the data scrambling circuit and an output; and
a signal output coupled to the output of the watermark insertion circuit.

2. The network-communicating device of claim 1 and further including a user-configurable circuit having an input adapted to receive a user-configurable parameter and an output coupled to the data scrambling circuit.

3. The network-communicating device of claim 2 wherein the user-configurable circuit is adapted to control the data scrambling circuit to select among a plurality of scrambling methods in response to the user-configurable parameter.

4. The network-communicating device of claim 3 wherein the plurality of scrambling methods include swapping data at different bit positions within a data block in response to either stored values or pseudo-randomly generated values.

5. The network-communicating device of claim 4 wherein the swapping data includes rotationally swapping data within the data block.

6. The network-communicating device of claim 4 wherein the swapping data includes swapping plural pairs of data within the data block.

7. The network-communicating device of claim 3 wherein the plurality of scrambling methods include swapping data at more than two bit positions within a data block.

8. The network-communicating device of claim 3 wherein the plurality of scrambling methods include swapping data at more than two bit positions within a data block in response to either stored values or pseudo-randomly generated values.

9. The network-communicating device of claim 1 and further including a user-configurable circuit having an input adapted to receive a user-configurable parameter and an output coupled to the watermark insertion circuit.

10. The network-communicating device of claim 9 wherein the user-configurable circuit is adapted to control the watermark insertion circuit to select among a plurality of watermark insertion methods in response to the user-configurable parameter.

11. The network-communicating device of claim 10 wherein the plurality of watermark insertion methods include inserting a single bit watermark indication between multi-bit ADC data values and inserting a multiple-bit watermark indication between multi-bit ADC data values.

12. The network-communicating device of claim 1:
wherein the ADC is adapted to output a sequence of N-bit data values; and
wherein the watermark insertion circuit is adapted to insert a watermark of N-bits into a stream of N-bit values output by the ADC.

13. The network-communicating device of claim 12 and further comprising count circuitry to determine a size of the stream of N-bit values.

14. The network-communicating device of claim 13 and further including a user-configurable circuit having an input adapted to receive a user-configurable parameter and an output coupled to control the size of the stream of N-bit values in response to the user-configurable parameter.

15. The network-communicating device of claim 1 and further including a user-configurable circuit having an input adapted to receive a first user-configurable parameter and an output coupled to the data scrambling circuit and a second user-configurable parameter and an output coupled to the watermark insertion circuit.

16. The network-communicating device of claim 15 wherein the user-configurable circuit is adapted to control the data scrambling circuit to select among a plurality of scrambling methods in response to the first user-configurable parameter and to control the watermark insertion circuit to select among a plurality of watermark insertion methods in response to the second user-configurable parameter.

17. The network-communicating device of claim 1 and further including a comparison circuit having a first data input coupled to receive a data value from the output of the ADC and a second data input adapted to receive a threshold level, the comparison circuit further including a control output adapted to selectively enable the data scrambling circuit in response to a comparison of the data value and the threshold level.

18. The network-communicating device of claim 1 and further including a sensor having an output coupled to the signal input of the ADC.

19. The network-communicating device of claim 1 and further including a transmitter circuit coupled to the output of the ADC and to the output of the watermark insertion circuit.

20. A network system, comprising:
a first network-communicating device adapted to be coupled to a network, comprising:
a signal input adapted to receive a sensor-derived signal;
an analog-to-digital converter (ADC) having an input coupled to the signal input and an output;
a data scrambling circuit having an input coupled to the output of the ADC and an output;
a watermark insertion circuit having an input coupled to the output of the data scrambling circuit and an output; and
a signal output coupled to the output of the watermark insertion circuit; and
a second network-communicating device, adapted to be coupled to the network and comprising processing circuitry adapted to process scrambled data with watermark information coupled to the network by the first network-communicating device.

21. A method comprising:
receiving an analog signal from a sensor;
determining, using an analog-to-digital converter, a first set of digital data associated with the analog signal;
determining whether to re-arrange a subset the first set of digital data to produce a second set of digital data or to provide the first set of digital data as the second set of digital data;
determining whether to insert a watermark in the second set of digital data to produce a third set of digital data or to provide the second set of digital data as the third set of digital data; and
providing the third set of digital data for transmission over a network.
